(19) United States
(12) Patent Application Publication
(10) Pub. No.: US 2015/0219391 A1
(43) Pub. Date: Aug. 6, 2015

(54) METHOD AND APPARATUS FOR RECOVERY OF CONDENSABLE GASES FROM LIQUID STORAGE TANKS

(71) Applicant: Air Liquide Industrial U.S. LP, Houston, TX (US)

(72) Inventors: Richard A. SAUER, Hinsdale, IL (US); John BUONASSISI, Downers Grove, IL (US); Rozalia PAPP, Orland Park, IL (US); David C. BRAITHWAITE, Houston, TX (US)

(21) Appl. No.: 14/610,427

(22) Filed: Jan. 30, 2015

Related U.S. Application Data
(60) Provisional application No. 61/935,913, filed on Feb. 5, 2014.
(60) Provisional application No. 62/040,010, filed on Aug. 21, 2014.
(60) Provisional application No. 62/042,277, filed on Aug. 27, 2014.
(60) Provisional application No. 62/042,280, filed on Aug. 27, 2014.

(51) Int. Cl. F25J 1/00; F17C 9/04

(52) U.S. Cl. CPC F25J 1/0015; F17C 9/04; F17C 2227/0128; F17C 2227/0365

(57) ABSTRACT

A method and apparatus for recovering boil-off gas from a head space of a liquid storage tank having a fluid contained therein is provided. The method can include the steps of withdrawing the boil-off gas from the storage tank and introducing said boil-off gas to a heat exchanger using a vapor flow inducer; cooling the boil-off gas in the heat exchanger by using cold energy from vaporization of liquid nitrogen to form a cooled fluid; and introducing the cooled fluid to the liquid storage tank, thereby reducing the temperature within the liquid storage tank.

### CROSS-REFERENCE TO RELATED APPLICATION

This application claims the benefit of U.S. Provisional Application 61/935,913, filed Feb. 5, 2014; U.S. Provisional Application 62/040,010, filed Aug. 21, 2014; U.S. Provisional Application 62/042,277, filed Aug. 27, 2014; and U.S. Provisional Application 62/042,280, filed Aug. 27, 2014, all of which are hereby incorporated by reference in their entireties.

### TECHNICAL FIELD OF THE INVENTION

The present invention relates to an apparatus and method for recovering condensable gases originating from a liquid storage tank. More specifically, embodiments of the present invention are related to recovering the condensable gases by introducing said condensable gases into a heat exchanger and cooling them against a vaporizing liquid nitrogen stream. The cooled condensable fluid is then reintroduced into the liquid storage tank, which provides further cooling to the liquid within the liquid storage tank.

### BACKGROUND OF THE INVENTION

As liquefied natural gas (LNG) becomes more readily available and the overall price declines, it becomes more economically practical to use LNG as a fuel for automotive purposes, particularly larger vehicles such as trucks and busses. However, before large scale use of LNG can occur, the appropriate infrastructure must be in place to service said vehicles.

As part of the infrastructure, fueling stations having liquid storage tanks can be used to provide the LNG. An inherent problem with storage tanks is that there is an inevitable loss of a certain amount of liquid product that fills the vapor space of the storage tank. This evaporated product is known as boil-off gas.

Under certain conditions, the amount of boil-off gas within the head space of the storage tank will increase, which will then lead to an increase in pressure within the storage tank. This could lead to an unsafe condition, and therefore, it has been common practice to include a venting mechanism with the storage tank, such as a pressure relief valve, that vents the boil-off gas to the atmosphere until the pressure within the storage tank is below a given threshold.

While this method of pressure control is cost effective, it has several drawbacks. Depending on the type of liquid contained within the storage tank, releasing the associated gas could be hazardous to the environment, increase fire hazards, and/or create noxious odors.

There have been proposed methods for preventing the need for venting, which can include condensing the boil-off gas, either internally or externally of the storage tank. However, many of these systems are overly complicated, include large pieces of equipment, and require that the boil-off gas be condensed before returning it to the storage tank.

Therefore, it would be desirable to have an improved process for recovering boil-off gas that was simple and efficient. Preferably, it would be desirable to have a process that did not require the use of complicated systems or very large pieces of equipment.

### SUMMARY OF THE INVENTION

The present invention is directed to a process that satisfies at least one of these needs. In one embodiment, the process for recovering boil-off gas from a liquid storage tank having a fluid contained therein is provided. In one embodiment, the method can include the steps of:
(a) measuring a condition selected from the group consisting of outside temperature, temperature within the liquid storage tank, pressure within the liquid storage tank, liquid level within the liquid storage tank, heat absorption by the liquid storage tank, and combinations thereof;
(b) withdrawing the boil-off gas from the liquid storage tank and introducing said boil-off gas to a heat exchanger using a vapor flow inducer, wherein the vapor flow inducer is configured to adjust the flow rate of the boil-off gas introduced to the heat exchanger based on the condition measured in step (a);
(c) cooling the boil-off gas in the heat exchanger by using cold energy from a flow of nitrogen to form a cooled fluid, wherein the heat exchanger is in fluid communication with an outlet of a liquid nitrogen storage tank, such that the heat exchanger is configured to receive a flow of nitrogen from the liquid nitrogen storage tank; and
(d) introducing the cooled fluid to the liquid storage tank, thereby reducing the temperature within the liquid storage tank,
wherein the flow rate of the boil-off gas withdrawn from the liquid storage tank to the heat exchanger and/or the flow rate of the nitrogen from the liquid nitrogen storage tank is adjusted, such that during the cooling step (c), BTUs of heat are removed from the boil-off gas faster than BTUs are gained by the liquid storage tank,
wherein the vapor flow inducer and the heat exchanger are disposed on a skid near ground level.

In optional embodiments:
the vapor flow inducer is selected from the group consisting of a vapor pump, a blower, and a fan; and/or
the vapor flow inducer is not a compressor.

In another embodiment of the invention, a method for recovering boil-off gas from a head space of a liquid storage tank having a fluid contained therein is provided. In one embodiment, the method can include the steps of withdrawing the boil-off gas from the storage tank and introducing said boil-off gas to a heat exchanger using a vapor flow inducer; cooling the boil-off gas in the heat exchanger by using cold energy from vaporization of liquid nitrogen to form a cooled fluid; and introducing the cooled fluid to the liquid storage tank, thereby reducing the temperature within the liquid storage tank.

In optional embodiments:
the vapor flow inducer and the heat exchanger are disposed on a skid;
the vapor flow inducer and the heat exchanger are disposed near ground level;
the boil-off gas is at least partially condensed during the step of cooling the boil-off gas in the heat exchanger;
the boil-off gas is not condensed during the step of cooling the boil-off gas in the heat exchanger;
the method can also include the step of varying the flow rate of the boil-off gas being introduced to the heat exchanger based on a measured value;
the measured value is selected from the group consisting of outside temperature, temperature within the liquid storage tank, pressure within the liquid storage tank, liquid level within the liquid storage tank, heat absorption by the liquid storage tank, and combinations thereof;
the step of cooling the boil-off gas in the heat exchanger further comprises the step of removing BTUs of heat from the boil-off gas faster than BTUs gained by the liquid storage tank, such that the pressure within the liquid storage tank is reduced;
the liquid storage tank is vacuum jacketed;
the fluid is a gas at atmospheric pressure and ambient temperatures;
the fluid is selected from the group consisting of liquid natural gas, argon, and ethylene; and/or
the method can also include the step of pressurizing the liquid nitrogen to a pressure such that the boiling point of the liquid nitrogen is warmer than the freezing point of the fluid.

In another embodiment of the invention an apparatus for recovering boil-off gas is provided. In one embodiment, the apparatus can include a liquid storage tank configured to contain a fluid in its liquid state disposed therein, wherein the fluid is a gas at atmospheric pressure and ambient temperatures; a liquid nitrogen storage tank configured to contain liquid nitrogen therein; a heat exchanger in fluid communication with a head space of the liquid storage tank and an outlet of the liquid nitrogen storage tank, the heat exchanger configured to transfer heat from the boil-off gas received from the head space of the liquid storage tank to the nitrogen received from the liquid nitrogen storage tank, thereby cooling the boil-off gas to produce a cooled fluid; a measuring device configured to measure a condition selected from the group consisting of outside temperature, temperature within the liquid storage tank, pressure within the liquid storage tank, liquid level within the liquid storage tank, heat absorption by the liquid storage tank, and combinations thereof; and a vapor flow inducer in fluid communication with the heat exchanger, the vapor flow inducer configured to adjust the flow rate of the boil-off gas received by the heat exchanger based on the condition measured by the measuring device.

In optional embodiments:
the vapor flow inducer and the heat exchanger are disposed on a skid;
the vapor flow inducer and the heat exchanger are disposed near ground level;
the liquid storage tank and the liquid nitrogen storage tank are vacuum jacketed;
the vapor flow inducer is selected from the group consisting of a vapor pump, a blower, and a fan;
the vapor flow inducer is not a compressor; and/or
the apparatus can also include a pressure increasing device in fluid communication with the liquid nitrogen storage tank and the heat exchanger, the pressure increasing device configured to pressurize the liquid nitrogen to a pressure such that the boiling point of the liquid nitrogen is warmer than the freezing point of the fluid within the liquid storage tank.

### BRIEF DESCRIPTION OF THE DRAWINGS

These and other features, aspects, and advantages of the present invention will become better understood with regard to the following description, claims, and accompanying drawings. It is to be noted, however, that the drawings illustrate only several embodiments of the invention and are therefore not to be considered limiting of the invention's scope as it can admit to other equally effective embodiments.

The FIGURE shows an embodiment of the present invention.

### DETAILED DESCRIPTION

While the invention will be described in connection with several embodiments, it will be understood that it is not intended to limit the invention to those embodiments. On the contrary, it is intended to cover all the alternatives, modifications and equivalence as may be included within the spirit and scope of the invention defined by the appended claims.

In certain embodiments of the invention, the system can include a vapor flow inducer, which can include anything that induces a flow without substantially increasing the pressure of the gas. In certain embodiments, the vapor flow inducer can be selected from the group consisting of a small vapor pump, a blower, and a fan. In one embodiment, the vapor flow inducer is not a compressor. In one embodiment, all the equipment can be at ground level, and optionally skidded together. This can greatly reduce the overall capital expenditure and time needed for installation. Additionally, since the heat exchanger can be located at the ground level, lengths of vacuum jacketed piping can be further minimized, which also further reduces the overall cost.

In one embodiment, the vapor flow inducer can run at a fixed speed. In another embodiment, the vapor flow inducer can be in operation whenever the pressure within the liquid storage tank is above a low pressure set point. In one embodiment, the vapor flow inducer is configured to circulate the boil-off gas until the pressure within the liquid storage tank falls below a measured set point.

In typical off-gas recovery systems, the heat exchanger is sized in order to liquefy the entire flow of the incoming off-gas; however, by operating more or less continuously, the heat exchanger of certain embodiments of the present invention can be sized smaller than normal, since the heat exchanger would not need to condense all of the boil-off gas. Instead, embodiments of the present invention advantageously can operate within safety guidelines by simply chilling the boil-off gas and returning it back to the liquid storage tank at a temperature that is lower than it previously was at, which thereby reduces the overall temperature within the liquid storage tank, which in turn reduces the amount of liquid boiling off in the liquid storage tank, thereby lowering the overall pressure within the liquid storage tank.

In one embodiment, the heat exchanger could be configured to be able to remove BTUs of heat from the boil-off gas faster than the steady state gain by the liquid storage tank, thereby reducing the overall temperature within the liquid storage tank.

Other typical off-gas recovery systems also use large heat exchangers that are sized in order to accommodate large events (e.g., loading and unloading of the liquid storage tank); however, these large events do not occur very often and therefore, the heat exchanger is typically oversized for a majority of its use. However, embodiments of the present invention allow for improved flow rates by using a forced flow, which in turn helps to prevent large fluctuations in internal pressures of the liquid storage tank, which in turn allows for the heat exchanger to be appropriately sized since it is not having to accommodate such large variations in flows.

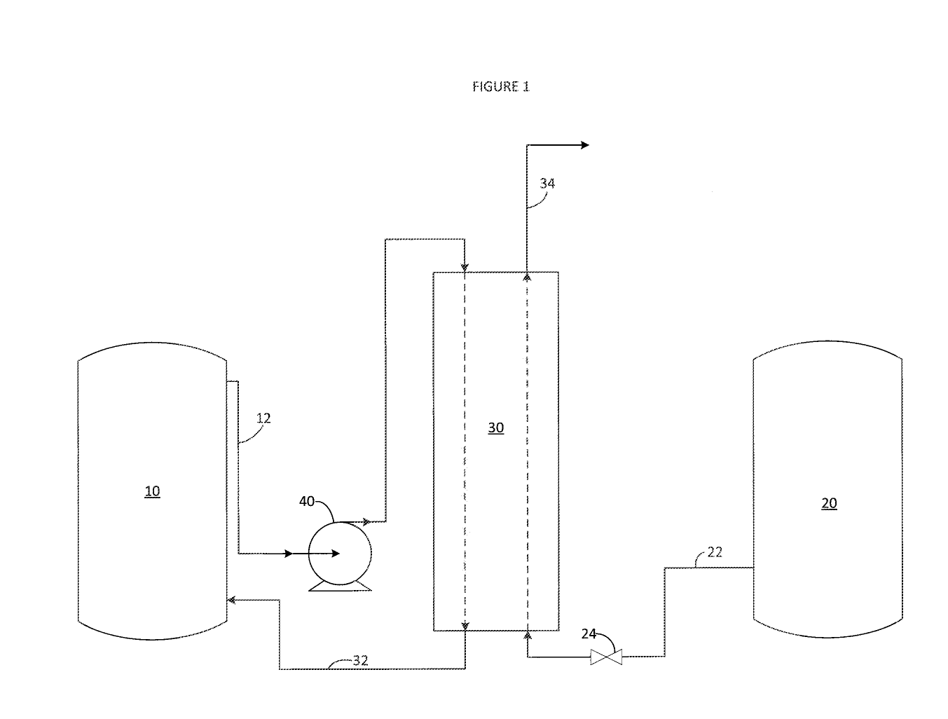

Now turning to FIG. 1, liquid storage tank 10 is filled with a liquid that would typically be gaseous under atmospheric pressure and ambient temperatures. As such, liquid storage tank 10 is operated at increased pressures and temperatures that are lower than ambient conditions. During the course of normal operation, a certain amount of the liquid within liquid storage tank 10 will vaporize and enter the head space within liquid storage tank 10 until an equilibrium is established. The amount of gaseous molecules within the head space is dependent on at least the volume of liquid storage tank 10, the volume of liquid within liquid storage tank 10, the pressure and temperature within liquid storage tank 10. As the temperature rises, the pressure within liquid storage tank 10 will also increase.

In one embodiment, whenever the pressure exceeds a lower set point, boil-off gas 12 is withdrawn from the head space of liquid storage tank 10 using vapor flow inducer 40. Boil-off gas 12 then flows from vapor flow inducer 40 to a warm end of heat exchanger 30, wherein boil-off gas 12 is cooled against a working fluid to form cooled fluid 32. Cooled fluid 32, which can be condensed liquid, or just cooled gas, is then reintroduced to liquid storage tank 10, effectively providing refrigeration to liquid storage tank 10.

In the embodiment shown, the working fluid is nitrogen. Liquid nitrogen storage tank 20 contains liquid nitrogen, which is fed to a cold end of heat exchanger 30 via line 22. The liquid nitrogen absorbs heat from boil-off gas 12, vaporizes and is then vented 34 to the atmosphere. Valve 24 can be used to help control the flow rate of the liquid nitrogen.

Additional embodiments can include monitoring of certain conditions. For example, the following conditions can all be monitored: outside temperature, temperature within the liquid storage tank, pressure within the liquid storage tank, liquid level within the liquid storage tank, and/or heat absorption by the liquid storage tank. Additionally, each of these conditions can then be used to control the flow rates of the boil-off gas and/or liquid nitrogen fed to the heat exchanger. In one embodiment, the flow rates can be varied in order to ensure that the amount of refrigeration introduced back to the liquid storage tank exceed the steady state heat gain by the liquid storage tank due to external forces (e.g., ambient air temperatures, loading/unloading of vessel).

In an additional embodiment, the method can also include adjusting the storage and/or operating pressure of the liquid nitrogen, such that the liquid nitrogen is warmer than the freezing point of the boil-off gas, thereby reducing the risk of solids forming within the heat exchanger and/or lines. As an example, argon becomes a solid at about −308° F. and nitrogen has a boiling point of about −321° F. at 1 atm. However, by maintaining liquid nitrogen within a pressure range of 20-30 psi, the boiling point of the liquid nitrogen rises to about −300° F. to −305° F., thereby eliminating the opportunity of creating solid argon.

While the invention has been described in conjunction with specific embodiments thereof, it is evident that many alternatives, modifications, and variations will be apparent to those skilled in the art in light of the foregoing description. Accordingly, it is intended to embrace all such alternatives, modifications, and variations as fall within the spirit and broad scope of the appended claims. The present invention may suitably comprise, consist or consist essentially of the elements disclosed and may be practiced in the absence of an element not disclosed. Furthermore, language referring to order, such as first and second, should be understood in an exemplary sense and not in a limiting sense. For example, it can be recognized by those skilled in the art that certain steps or devices can be combined into a single step/device.

The singular forms “a”, “an”, and “the” include plural referents, unless the context clearly dictates otherwise.

Optional or optionally means that the subsequently described event or circumstances may or may not occur. The description includes instances where the event or circumstance occurs and instances where it does not occur.

Ranges may be expressed herein as from about one particular value, and/or to about another particular value. When such a range is expressed, it is to be understood that another embodiment is from the one particular value and/or to the other particular value, along with all combinations within said range.

We claim:

1. A method for recovering boil-off gas from a head space of a liquid storage tank having a fluid contained therein, the method comprising the steps of:
(a) measuring a condition selected from the group consisting of outside temperature, temperature within the liquid storage tank, pressure within the liquid storage tank, liquid level within the liquid storage tank, heat absorption by the liquid storage tank, and combinations thereof;
(b) withdrawing the boil-off gas from the liquid storage tank and introducing said boil-off gas to a heat exchanger using a vapor flow inducer, wherein the vapor flow inducer is configured to adjust the flow rate of the boil-off gas introduced to the heat exchanger based on the condition measured in step (a);
(c) cooling the boil-off gas in the heat exchanger by using cold energy from a flow of nitrogen to form a cooled fluid, wherein the heat exchanger is in fluid communication with an outlet of a liquid nitrogen storage tank, such that the heat exchanger is configured to receive a flow of nitrogen from the liquid nitrogen storage tank; and
(d) introducing the cooled fluid to the liquid storage tank, thereby reducing the temperature within the liquid storage tank,
wherein the flow rate of the boil-off gas withdrawn from the liquid storage tank to the heat exchanger and/or the flow rate of the nitrogen from the liquid nitrogen storage tank is adjusted, such that during the cooling step (c), BTUs of heat are removed from the boil-off gas faster than BTUs are gained by the liquid storage tank,
wherein the vapor flow inducer and the heat exchanger are disposed on a skid near ground level.

2. The method as claimed in claim 1, wherein the vapor flow inducer is selected from the group consisting of a vapor pump, a blower, and a fan.

3. The method as claimed in claim 1, wherein the vapor flow inducer is not a compressor.

4. A method for recovering boil-off gas from a head space of a liquid storage tank having a fluid contained therein, the method comprising the steps of:
withdrawing the boil-off gas from the storage tank and introducing said boil-off gas to a heat exchanger using a vapor flow inducer;
cooling the boil-off gas in the heat exchanger by using cold energy from vaporization of liquid nitrogen to form a cooled fluid; and
introducing the cooled fluid to the liquid storage tank, thereby reducing the temperature within the liquid storage tank.

5. The method as claimed in claim 4, wherein the vapor flow inducer and the heat exchanger are disposed on a skid.

6. The method as claimed in claim 4, wherein the vapor flow inducer and the heat exchanger are disposed near ground level.

7. The method as claimed in claim 4, wherein the boil-off gas is at least partially condensed during the step of cooling the boil-off gas in the heat exchanger.

8. The method as claimed in claim 4, wherein the boil-off gas is not condensed during the step of cooling the boil-off gas in the heat exchanger.

9. The method as claimed in claim 4, further comprising the step of varying the flow rate of the boil-off gas being introduced to the heat exchanger based on a measured value.

10. The method as claimed in claim 9, wherein the measured value is selected from the group consisting of outside temperature, temperature within the liquid storage tank, pressure within the liquid storage tank, liquid level within the liquid storage tank, heat absorption by the liquid storage tank, and combinations thereof

11. The method as claimed in claim 4, wherein the step of cooling the boil-off gas in the heat exchanger further comprises the step of removing BTUs of heat from the boil-off gas faster than BTUs gained by the liquid storage tank, such that the pressure within the liquid storage tank is reduced.

12. The method as claimed in claim 4, wherein the liquid storage tank is vacuum jacketed.

13. The method as claimed in claim 4, wherein the fluid is a gas at atmospheric pressure and ambient temperatures.

14. The method as claimed in claim 4, wherein the fluid is selected from the group consisting of liquid natural gas, argon, and ethylene.

15. The method as claimed in claim 4, further comprising pressurizing the liquid nitrogen to a pressure such that the boiling point of the liquid nitrogen is warmer than the freezing point of the fluid.

16. An apparatus for recovering boil-off gas, the apparatus comprising:
a liquid storage tank configured to contain a fluid in its liquid state disposed therein, wherein the fluid is a gas at atmospheric pressure and ambient temperatures;
a liquid nitrogen storage tank configured to contain liquid nitrogen therein;
a heat exchanger in fluid communication with a head space of the liquid storage tank and an outlet of the liquid nitrogen storage tank, the heat exchanger configured to transfer heat from the boil-off gas received from the head space of the liquid storage tank to the nitrogen received from the liquid nitrogen storage tank, thereby cooling the boil-off gas to produce a cooled fluid;
a measuring device configured to measure a condition selected from the group consisting of outside temperature, temperature within the liquid storage tank, pressure within the liquid storage tank, liquid level within the liquid storage tank, heat absorption by the liquid storage tank, and combinations thereof; and
a vapor flow inducer in fluid communication with the heat exchanger, the vapor flow inducer configured to adjust the flow rate of the boil-off gas received by the heat exchanger based on the condition measured by the measuring device.

17. The apparatus as claimed in claim 16, wherein the vapor flow inducer and the heat exchanger are disposed on a skid.

18. The apparatus as claimed in claim 16, wherein the vapor flow inducer and the heat exchanger are disposed near ground level.

19. The apparatus as claimed in claim 16, wherein the liquid storage tank and the liquid nitrogen storage tank are vacuum jacketed.

20. The apparatus as claimed in claim 16, wherein the vapor flow inducer is selected from the group consisting of a vapor pump, a blower, and a fan.

21. The apparatus as claimed in claim 16, wherein the vapor flow inducer is not a compressor.

22. The apparatus as claimed in claim 16, further comprising a pressure increasing device in fluid communication with the liquid nitrogen storage tank and the heat exchanger, the pressure increasing device configured to pressurize the liquid nitrogen to a pressure such that the boiling point of the liquid nitrogen is warmer than the freezing point of the fluid within the liquid storage tank.
